(19) United States
(12) Patent Application Publication
(10) Pub. No.: US 2013/0262227 A1
(43) Pub. Date: Oct. 3, 2013

(54) PROCESS AND SYSTEM OF COUPON DISTRIBUTION

(71) Applicant: FLOCK TAG LLC, Ann Arbor, MI (US)

(72) Inventors: David Lin, Ann Arbor, MI (US); Adrian Fortino, Northville, MI (US)

(73) Assignee: Flock Tag LLC, Ann Arbor, MI (US)

(21) Appl. No.: 13/852,912

(22) Filed: Mar. 28, 2013

Related U.S. Application Data
(60) Provisional application No. 61/616,862, filed on Mar. 28, 2012.

(51) Int. Cl. G06Q 30/02

(52) U.S. Cl. CPC G06Q 30/0224
USPC 705/14.53

(57) ABSTRACT

A process and system are provided for coupon distribution that weights the coupon value to customer frequency and purchase behavior is provided. A collaborative marketing system for dissimilar vendors is provided. The system facilitates coordination between vendors with one another by offering promotions and coupons to customers from dissimilar vendors that offer noncompeting products or services. In embodiments appropriate incentives are generated, to entice customers to visit previously untried or infrequently visited associate vendors, thereby increasing revenues for an associate vendor. The system allows a business to automatically control the cost of discounts, and the allocation of discounts among different categories of customers and potential customers and is operative in instances when the dissimilar vendors are proximal store fronts, as well as geographically remote store fronts and web-based businesses. The process and system are is suitable for the sale of goods, services, or a combination thereof.

### CROSS-REFERENCE TO RELATED APPLICATIONS

This application is a non-provisional application that claims priority benefit of U.S. Provisional Application Ser. No. 61/616,862, filed Mar. 28, 2012 the contents of which are hereby incorporated by reference.

### FIELD OF THE INVENTION

The present invention in general relates to a process and system for coupon distribution and in particular to a process and system for coupon distribution that weights the coupon value to customer frequency and purchase behavior.

### BACKGROUND OF THE INVENTION

Small businesses are in dire need of new, cost effective marketing strategies. Small businesses have difficulty marketing their products and services in today's world. Technological innovations are drastically changing the competitive landscape and small business owners do not have the resources to keep up. Mobile phones and smart-phones are adding more complexity (and opportunity) as the digital world and the real world coalesce. Large firms are able to take full advantage of these technologies. Large firms can participate in high investment online and mobile marketing programs. Most importantly, large firms can measure the effectiveness of most marketing efforts which enables these firms to learn, improve and innovate. As time and technology progress, the technology gap between small and large businesses will get larger.

Small businesses are also missing out on any opportunities involving collaboration between neighboring businesses. It is difficult for small business owners to coordinate with each other because they are too busy managing their own businesses and many are not strong marketers in the first place. This results in a myopic world-view and a limited reach. By working together, non-competitive businesses can attract more people into their stores with minimal marketing investment. This results in more customers coming in more frequently resulting in increased revenues.

Thus, there exists a need for neighborhood businesses to collaborate in effective marketing of their products and services without needing to commit extensive time and resources. There also exists a need for distributing promotions and coupons through mobile devices which is convenient since it eliminates the need to carry paper coupons, is direct since it reaches the target customer's device, and it is immediate since it eliminates the postal delays associated with tradition methods of distribution.

### SUMMARY OF THE INVENTION

An inventive process and system for coupon distribution that weights the coupon value to customer frequency and purchase behavior is provided. Embodiments of the present invention have utility for serving as a collaborative marketing system for dissimilar vendors. The system facilitates coordination between vendors with one another by offering promotions and coupons to customers from dissimilar vendors that offer noncompeting products or services. In embodiments appropriate incentives are generated, to entice customers to visit previously untried or infrequently visited associate vendors, thereby increasing revenues for an associate vendor. Embodiments of an inventive system also allow a business to automatically control the cost of discounts, and the allocation of discounts among different categories of customers and potential customers. By way of example, by allocating high-value coupons to potential customers, they are induced to shop with an associate business while a regular customer is offered a comparatively modest value coupon. Embodiments of the present invention are operative in instances when the dissimilar vendors are proximal store fronts, as well as geographically remote store fronts and web-based businesses. Embodiments of the present invention are suitable for the sale of goods, services, or a combination of both goods and services.

### BRIEF DESCRIPTION OF THE DRAWINGS

FIG. 1 is a high-level block diagram schematic of an inventive system for coupon distribution;

FIG. 2 is a schematic of the core components of an inventive system for distribution of coupons and promotions comprising of databases, processing modules, and output modules;

FIG. 3 is a schematic of the subsystem structure of a processing module of an inventive system;

FIG. 4 is the information processing flow diagram in vendor groups generation subsystem of the processing module of FIG. 3;

FIG. 5 is the information processing flow diagram in coupon recipient selection subsystem of an inventive processing module; and

FIG. 6 is the information processing flow diagram for coupon valuation subsystem of an inventive processing module.

### DETAILED DESCRIPTION OF THE INVENTION

The present invention has utility for serving as a collaborative marketing system for dissimilar vendors. The system facilitates coordination between vendors with one another by offering promotions and coupons to customers from dissimilar vendors that offer noncompeting products or services. With appropriate incentives, customers visit previously untried or infrequently visited associate vendors thereby increasing revenues for an associate vendor. An inventive system also allows a business to automatically control the cost of discounts and the allocation of discounts among different categories of customers and potential customers. By way of example, by allocating high-value coupons to potential customers, they are induced to shop with an associate business while a regular customer is offered a comparatively modest value coupon. The present invention is operative in instance when the dissimilar vendors are proximal store fronts, as well as geographically remote store fronts and web-based businesses. The present invention is suitable for the sale of goods, services, or a combination of both goods and services.

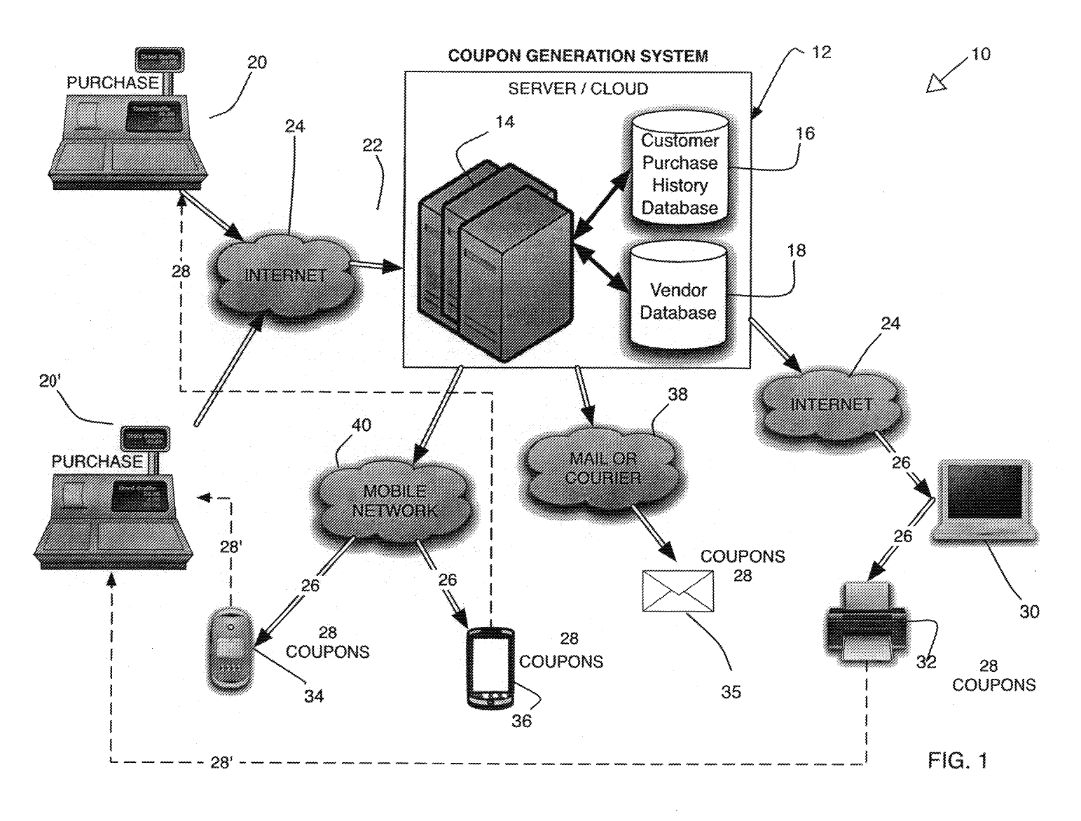

Illustrated in FIG. 1 is a high-level block diagram of an inventive coupon generation system. An inventive system is shown generally at 10. The system 10 has a coupon generation system shown at 12 that is either a cloud, or local-server based computation and processing server 14. The server 14 is in communication with a customer purchase history database 16 and a vendor database 18. The customer database 16 records data gathered related to customer buying history and associates the information with an email, Internet Protocol (IP) address, phone number, postal address or other contact information for the customer. Customer base information may also optionally include customer demographics. It is appreciated that the customer data is optionally parsed to note time of day of shopping, categories of merchandise purchased, and mode of payment. The database 18 includes predetermined information about participating vendors. It is appreciated that the databases 16 and 18 are readily integrated into a unified database or the information content spread among existing databases with the proviso the data is accessible for usage by the system 10.

The system 10 has a first data upload device 20 for inputting customer purchase information is provided. The device 20 is located with a first vendor and illustratively includes a computer; a reader such as a visual scanner, a code scanner, a magnetic scanner, or a radiofrequency scanner; or an electronic cash register. Regardless of the specific device 20, a first vendor customer information is communicated to the server 14 at 22. While in FIG. 1 as communication by the Internet 24, it is appreciated that the information communication is readily performed by intranet, or simply that the server 14 and databases 16 and 18 is integral within the device 20.

Information from the point of sale 20 is communicated to the server 14 and stored in the database 16. In an embodiment of the invention, the databases 16 and 18 are distributed and implemented to store information readily accessible from the Internet 24. At some predefined intervals, or upon the occurrence of a predetermined event, the coupon generation system 12 communicates a coupon generation signal 26 for a coupon 28 to a customer addressed device of a computer 30 for printing of the coupon 28 on a printer 32, or a mobile device 34 or a smart phone 36. The signal 26 being communicated via a wired or wireless connection through the Internet 24 or a mobile network 40. The customized coupon 26 is for use by a predetermined customer or group of customers. The generated coupon 28 after being distributed to a customer as detailed above to computer 30, mobile device 34 or smart phone 36, or by direct mailing through the postal or courier services 38. The recipients of coupon 28 receives products, services, or both, at a discounted price redeemable with the first vendor through device 20 as shown in FIG. 1 or with a second vendor data upload device 20′ for a second vendor coupon denoted in FIG. 1 at 28′. Optionally, the redemption history of a coupon 28 or 28′ by the recipient customer is collected and communicated to the server 14 and customer database 16 as a basis for generating additional coupons.

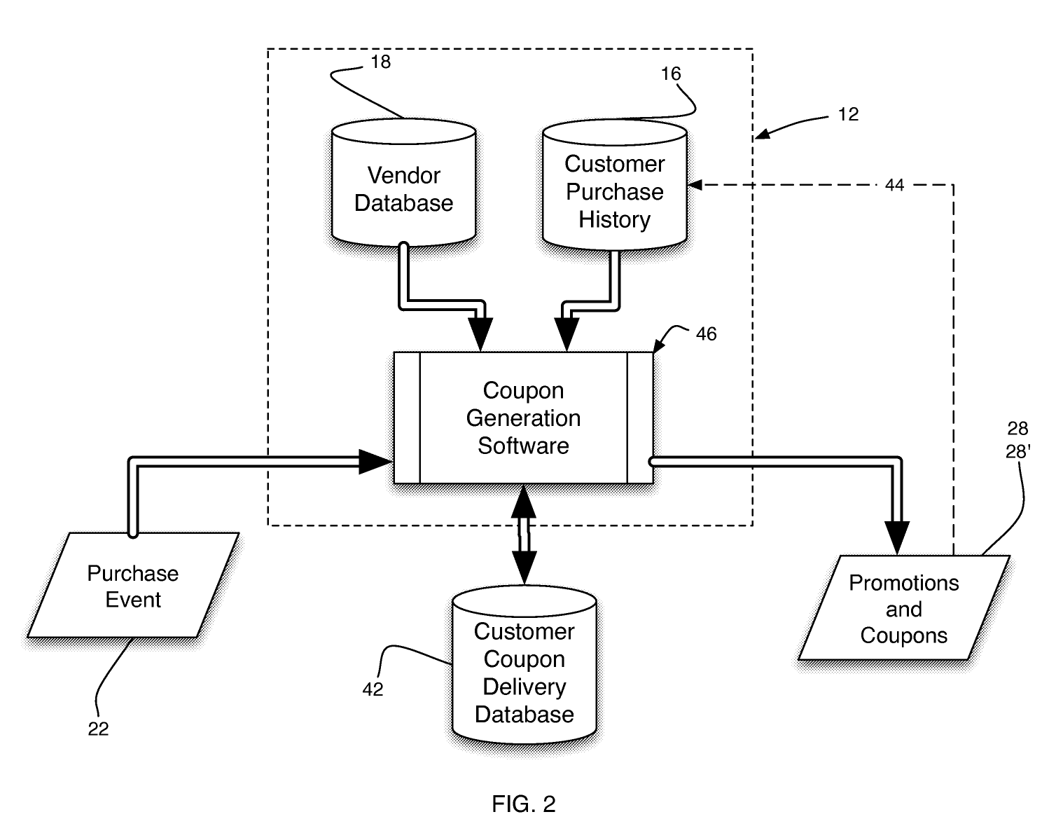

FIG. 2 represents the interaction of process modules, and output modules for the inventive system 10 of FIG. 1 where like numerals used in this figure have the meanings attributed thereto in FIG. 1. The vendor database 18 records and tracks information about participating vendors, their geographical locations, and other predetermined parameters indicative of level of participation by a vendor in the system 10 including the value and frequency of coupons the vendor wishes to distribute. The level of participation of a vendor thereby determines the number of coupons, the offering category to which the coupons apply, and the differential value for different categories of customers the system 10 will distribute for that vendor.

The database of customers and their purchase history is maintained in the customer purchase history database 16. Specifically, customer purchase history database 16 includes customer contact information, and the date of a purchase. Additional optional data collected includes predefined details about the purchases made by the customer wherein details illustratively include the vendor identity and location where the purchase was made, the date and time of purchase, the amount of purchase, and the plurality of coupons used in the purchase.

The customer coupon delivery history database records and tracks predefined information about coupons that are sent to customers. Specifically included in the customer coupon delivery history database 42 is information about the vendors whose coupons were sent to the customer over a predefined period of time; other optional information stored in the database 42 illustratively includes the date coupons were sent, face value of coupons sent, expiration date of the coupon sent, and whether or not the customer used the coupons sent.

In a specific embodiment of the present invention, customer purchase history database 16, vendor database 18, and customer coupon delivery database 42 are all combined into a single database (not shown). In another embodiment of the invention, a subset of customer purchase history database 16, vendor database 18, and customer coupon delivery database 42 are combined into a single database. Optionally, information of coupon redemption history 44 is also communicated and stored in accessible form to the database 16. The data of the various databases 16, 18, and 42 is accessed by coupon generation software 46 in generating coupons 28 and 28′ according to vendor criteria as, for example, detailed above.

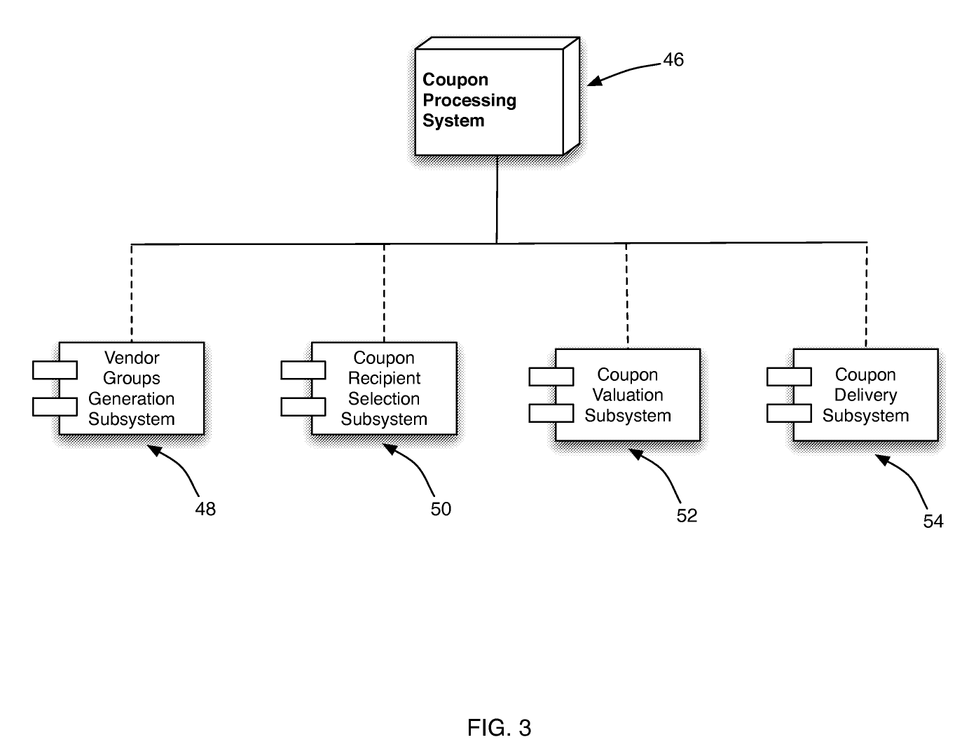

The components of the coupon generation software 46 for processing data, generating and distributing coupons, are shown in FIG. 3. The processing module of the coupon generation system disclosed uses information contained in these databases to generate marketing and promotions including coupons. As illustrated, the processing module of the coupon generation system optionally has subsystems including vendor group generation subsystem 48, coupon recipient selection subsystem 50, coupon valuation subsystem 52, and coupon delivery subsystem 54. The vendor group generation subsystem is based on algorithms utilizing vendor inputs of the value of coupons to be offered, the restrictions on coupon redemption as to time or product offerings. The software also optionally has a coupon recipient selection 50 that queries the customer purchase database 16 for target based on purchase behavior customers to receive coupons. It should be appreciated that a customer denotes a customer of at least one associated business and is not necessarily and indeed is often preferred to not be a regular customer of the vendor issuing the coupons. A coupon valuation subsystem 52 includes user defined allocation as to coupon number and value for a given class of customer. Customer classes cover an exemplary spectrum from daily customer through infrequent customer to non-customer of the given vendor. Through the pooling of customer data from dissimilar businesses, the present invention allows vendors to efficiently broaden their respective customer base with value appropriate coupons for each class of their specific customers.

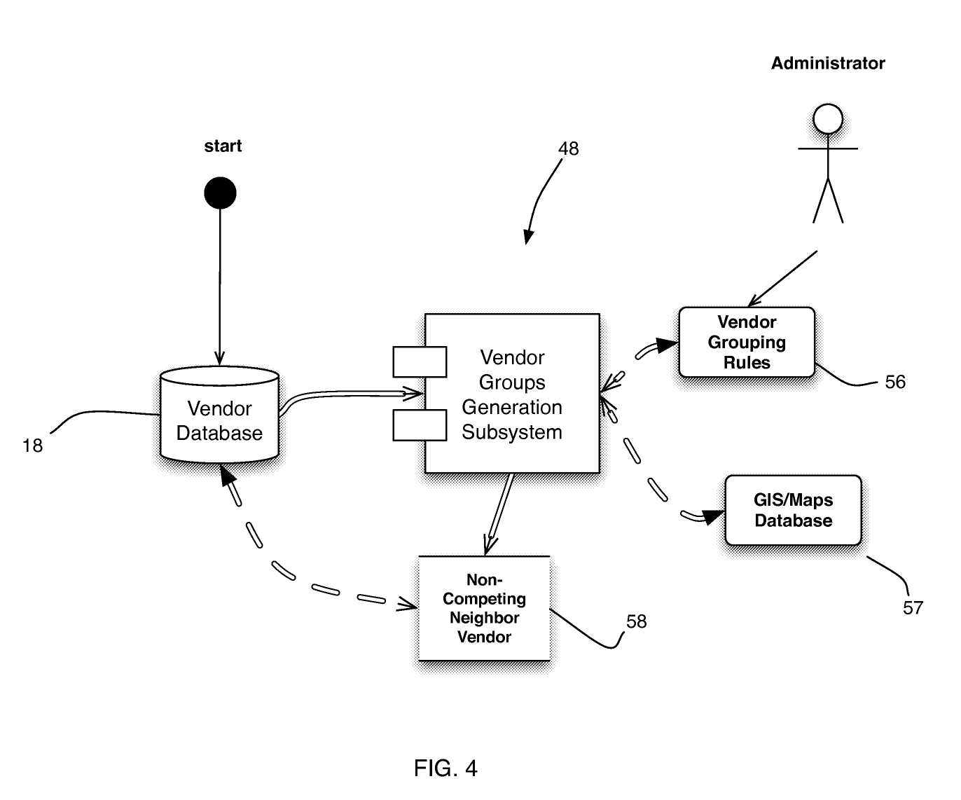

FIG. 4 illustrates the information processing flow in vendor groups generation subsystem 48 of the coupon generation software 46. Vendor group generation subsystem 48 analyzes a criterion of a first vendor such as geographical location 57, participation in a special event, or an overlap in customer demographic overlap, offered categories of product/service designation offered by the first vendor, prospective categories of product/service designation predetermined by the first vendor, an administrator of the disclosed system, or a combination of such inputs. Preferably, vendors are associated that are found to non-competitive as to geography or product offerings. The term non-competitive should not be construed as absolute but rather as having a Gaussian overlap of less than 2 sigma, and preferably, less than 3 sigma. Vendor group generation subsystem 48 selects vendors for cross-advertising to form a non-competing vendor group 58 from the vendor database 18 based on database queries or simply through administrator input based on a creating vendor grouping rules 56.

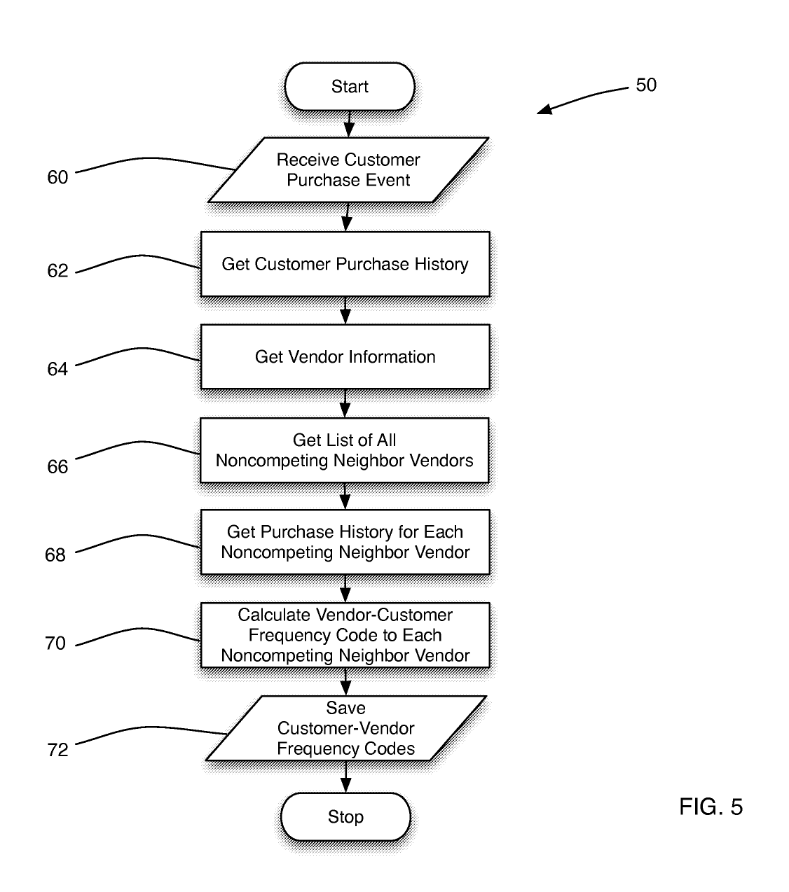

FIG. 5 is a specific embodiment of information processing flow in coupon recipient selection subsystem 50. It is appreciated that there exist logical variants of this flow that will be apparent to one of skill in the art that do not depart from to functional output of subsystem 50. The function of the coupon recipient selection subsystem 50 is to identify a customer, or classes of customers, who are selected to receive coupons or promotions distributed by the disclosed system. In an embodiment of the invention, purchase made by a customer initiates the system that causes coupons to be generated. In an embodiment of the invention, coupon generation is initiated at a predetermined time, or at predetermined frequency.

In an embodiment of the invention shown in FIG. 5, the coupon recipient selection subsystem 50 receives a customer purchase event 60, which in is used to retrieve a history of purchases 62 made by the customer over a predetermined period from the customer purchase history database 16 to retrieve vendor information 64. Identity of a first vendor where the purchase was made is used to retrieve a relevant vendor group for the first vendor 66. Frequency of purchases made by the customer for each vendor in the noncompetitive group is next used to associate a frequency code with each vendor in the noncompetitive group 68. In an embodiment of the invention the frequency code is used to prioritize the value of the coupon sent to a given customer 70 and preferably afford differential value coupons to different classes of customers for a given vendor. More preferably, coupon value is inversely proportional to the frequency/purchase amount by a class of customers. Customer frequency/value codes for a given vendor of the inventive system are optionally saved 72 before the routine is completed.

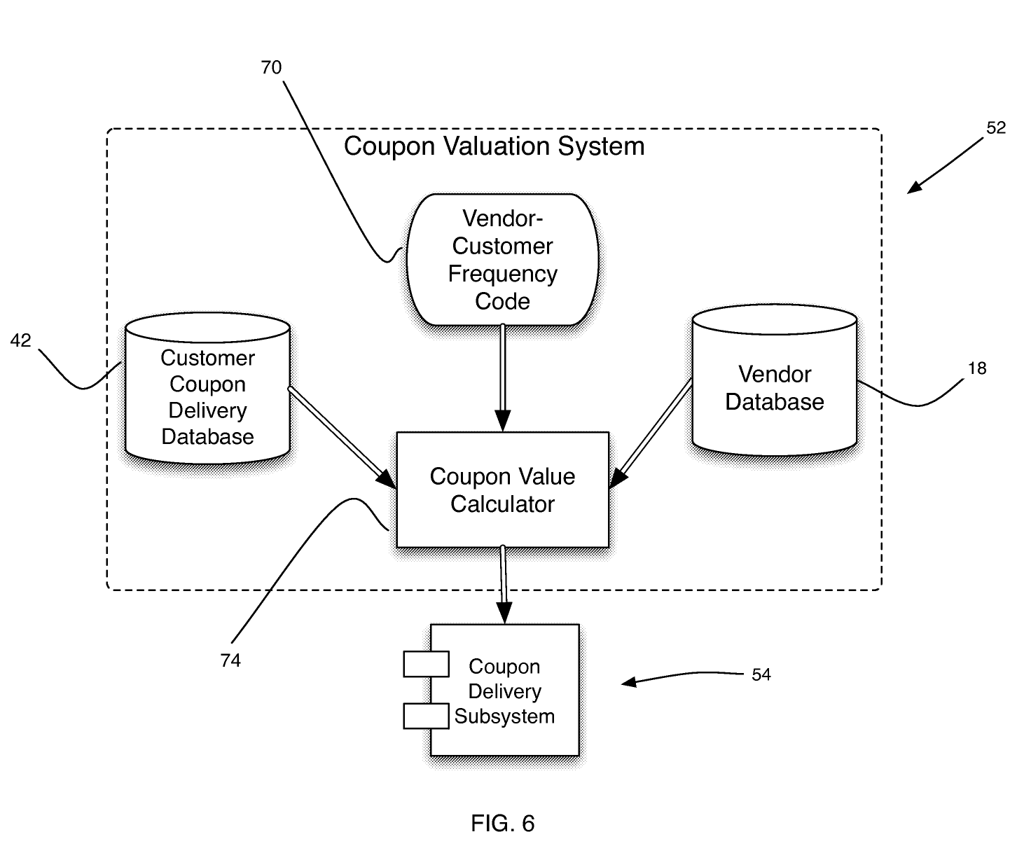

FIG. 6 illustrates the information processing flow for coupon valuation subsystem 52 where like numerals have the meaning ascribed thereto with respect to the aforementioned figures. The function of this subsystem 52 is to allocate a coupon discount amount, or coupon discount percentage, to be distributed to a given customer as a member of a customer class. The history of coupons delivered to the customer 42, the customer-vendor frequency codes 70 generated by the coupon recipient selection subsystem 50 corresponding to the customer purchase, and budgetary allocation for each vendor in the noncompetitive group recorded in vendor database 18, are illustratively used in determining the of face value of the coupon. It is appreciated that a subset of inputs 42, 70, and 18 are optionally used to ascribe coupon value 74. The coupon delivery subsystem 54 receives details for a coupon from the coupon valuation subsystem 52 for delivery to a customer. The coupon delivery subsystem 54 consults the preferential delivery modes specified in the customer database 16. The coupon 28 or 28′ is delivered through an electronic mail message to the customer, sending a predetermined code to a mobile or electronic device, sending a media message to a mobile or electronic device, or sending a transcribed coupon to through a postal or other form of mailing or courier service.

The foregoing description is illustrative of particular embodiments of the invention, but is not meant to be a limitation upon the practice thereof. The following claims, including all equivalents thereof, are intended to define the scope of the invention.

1. A system for coupon distribution comprising:
a database storing first vendor customer information, said first vendor customer information including at least for each of a plurality of first vendor customers a frequency of purchase from a first vendor and a first vendor customer electronic device address, the first vendor having a first vendor product line;
said database or a second connected database storing second vendor customer information, said second vendor customer information comprising for each of a plurality of second vendor customers a frequency of purchase from a second vendor and a second vendor customer electronic device address, the second vendor having a second vendor product line or geographic non-overlap different than the first vendor product line or first vendor customer geographic distribution;
a user input allocating a total value of a plurality of coupons apportioned so as to provide a first coupon from said plurality of coupons to a high frequency first customer of said plurality of first vendor customers and a second coupon of said plurality of coupons to a second vendor customer who is not one of said plurality of first vendor customers, said first coupon and said second coupon differing in value; and
a network for distributing electronic signals corresponding to said first coupon to the first vendor customer electronic device address of said high frequency customer and said second coupon to the second vendor customer electronic device address of said second vendor customer.

2. The system of claim 1 further comprising a reader device located in a first vendor retail facility for reading said first coupon or said second coupon.

3. The system of claim 2 further comprising an interface between said reader and said database for conveying details of said reading and updating said database.

4. The system of claim 2 further comprising a second reader device located in a second vendor facility for reading said first coupon or said second coupon.

5. The system of claim 1 wherein said first vendor and said second vendor offer dissimilar product offerings.

6. The system of claims 1 wherein said first vendor and said second vendor have the geographically non-overlapping customers and similar product offerings.

7. The system of claims 1 further comprising coupon generation software operating to allocate said plurality of coupons.

8. The system of claim 1 wherein said network is an electronic mail message system, a predetermined code system, a media messaging system, or sending a transcribed coupon via a postal service or courier service.

9. A process for coupon distribution comprising:
collecting first vendor customer information from a first vendor, said first vendor customer information including at least for each of a plurality of first vendor customers a frequency of purchase from a first vendor and a first vendor customer electronic device address, the first vendor having a first vendor product line;
storing said first vendor customer information in a database;
collecting second vendor customer information from a second vendor, said second vendor customer information including at least for each of a plurality of second vendor customers a frequency of purchase from a second vendor and a second vendor customer electronic device address, the second vendor having a second vendor product line or geographic non-overlap different than the first vendor product line or first vendor customer geographic distribution;
storing said second vendor customer information in a database;
allocating a total value of a plurality of coupons apportioned so as to provide a first coupon from said plurality of coupons to a high frequency first customer of said plurality of first vendor customers and a second coupon of said plurality of coupons to a second vendor customer who is not one of said plurality of first vendor customers, said first coupon and said second coupon differing in value; and
distributing said first coupon to the first vendor customer and said second coupon to the second vendor customer.

10. The process of claim 9 further comprising calculating a customer-vendor frequency code for each of said first vendor and said second vendor for use in the allocating step.
